(19) United States
(12) Patent Application Publication
(10) Pub. No.: US 2025/0054498 A1
(43) Pub. Date: Feb. 13, 2025

(54) METHOD AND APPARATUS FOR SYSTEM COMMAND VERIFICATION

(71) Applicant: Stoneridge Electronics AB, Solna (SE)

(72) Inventor: Dominik MARX, Novi, MI (US)

(21) Appl. No.: 18/723,638

(22) PCT Filed: Dec. 7, 2022
(86) PCT No.: PCT/US2022/052078

§ 371 Date: Jun. 24, 2024

Related U.S. Application Data
(60) Provisional application No. 63/293,184, filed on Dec. 23, 2021.

(51) Int. Cl. G10L 15/25; G10L 15/22; H04N 23/90

(52) U.S. Cl. CPC G10L 15/25; G10L 15/22; H04N 23/90; G10L 2015/223

(57) ABSTRACT

A commercial vehicle including a vehicle cab including a camera system having at least one field of view, the at least one field of view including at least one of a vehicle operator seat and an expected head position of a vehicle operator in the vehicle operator seat, at least one microphone configured to record sounds within the vehicle cab, and a controller configured to receive the recorded sounds and video feed from the camera system, the controller being further configured to identify at least one voice command based on the received recorded sounds and confirm the at least one voice command using the video feed from the camera system.

### CROSS-REFERENCE TO RELATED APPLICATION

This application claims priority to U.S. Provisional Patent Application No. 63/293,184 filed on Dec. 23, 2021.

### TECHNICAL FIELD

The present disclosure relates generally to voice command systems for a vehicle, and more specifically to a system for confirming that voice commands are from an authorized source.

### BACKGROUND

Automobiles, such as commercial vehicles, include complex operating systems having multiple control schemes. One system derived to simplify the controls for the vehicle operator is an audio command system. The audio command system uses software to monitor a soundwave reading from a microphone and interpret the soundwave reading. When the soundwave reading is within a margin of error of a predetermined pattern, the control system interprets the audio signal as a corresponding command and implements the command.

In vehicles having multiple operators, or one operator and one or more passengers, existing systems are unable to determine whether a command is being recited by the vehicle operator, or another authorized operator, or whether the command is being recited by an unauthorized user. In addition, other noise sources such as a radio or smart phone can inadvertently produce audible command phrases through normal usage. In order to mitigate this, some existing systems utilize non-intuitive commands that are not similar to conventional phrases or speech patterns. One downside to this approach is that this style command is more difficult to remember and does not reduce the complexity of operation as much as can be desired.

### SUMMARY OF THE INVENTION

In one exemplary embodiment a commercial vehicle includes a vehicle cab including a camera system having at least one field of view, the at least one field of view including at least one of a vehicle operator seat and an expected head position of a vehicle operator in the vehicle operator seat, at least one microphone configured to record sounds within the vehicle cab, and a controller configured to receive the recorded sounds and video feed from the camera system, the controller being further configured to identify at least one voice command based on the received recorded sounds and confirm the at least one voice command using the video feed from the camera system.

In another example of the above described commercial vehicle confirming the at least one voice command using the camera system video feed includes identifying a source of the voice command as being the vehicle operator using the camera system video feed.

In another example of any of the above described commercial vehicles identifying the source of the at least one voice command includes detecting at least one of a physical action and a physical positioning corresponding to the command in the video feed at the same time as the audio command in the audio feed.

In another example of any of the above described commercial vehicles the physical action includes at least one of lip movement, a predefined gesture, a change in head position, a change in gaze direction, a posture alteration, and facial movement.

In another example of any of the above described commercial vehicles the physical action is lip movement and confirming the at least one voice command includes lip reading the vehicle operator.

In another example of any of the above described commercial vehicles identifying the source of the at least one voice command includes identifying a posture or gaze direction of the vehicle operator.

In another example of any of the above described commercial vehicles identifying the source of the at least one voice command further includes contextualizes the voice command to one of a plurality of eligible vehicle systems based on the at least one of the physical action and the physical positioning.

In another example of any of the above described commercial vehicles the camera system includes a single camera and wherein the at least one field of view includes each of the vehicle operator seat and at least one vehicle passenger seat.

In another example of any of the above described commercial vehicles the camera system includes at least two cameras, a first camera defining a field of view including the vehicle operator and a second camera defining a field of view including at least one vehicle passenger seat.

In one exemplary embodiment a commercial vehicle controller includes at least one audio input configured to connect to an audio sensor and at least one video input, and a processor and a non-transitory memory, the non-transitory memory being configured to cause the processor identify at least one voice command based on audio received at the audio input and to confirm the at least one voice command using a video feed received at the at least one video input.

In another example of the above described commercial vehicle controller the memory includes a confirmation module configured to confirm the at least one voice command using the received video feed by identifying a source of an audio command based on a simultaneous physical action within the video feed.

In another example of any of the above described commercial vehicle controllers the simultaneous physical includes at least one of lip movement, a predefined gesture, a change in head position, a change in gaze direction, a posture alteration, and facial movement.

In another example of any of the above described commercial vehicle controllers the simultaneous physical action is the lip movement and the confirmation module includes instructions configured to convert lip movement to words.

In another example of any of the above described commercial vehicle controllers the instructions configured to convert lip movements to words include conversion instructions determined via machine learning trained using at least a data set of subtitled film footage.

In another example of any of the above described commercial vehicle controllers the simultaneous physical action includes at least one of a change in gaze direction and a change in posture, and wherein the controller is further configured to contextualize the command based at least in part on the at least one of the change in gaze direction and the change in posture.

In another example of any of the above described commercial vehicle controllers at least one audio input configured to connect to an audio sensor and at least one video input, wherein the at least one video input includes at least two video inputs and a first of the at least two video inputs is configured to receive a video feed defining a field of view including an expected position of a vehicle operator.

An exemplary method for verifying an audio command in a commercial vehicle includes receiving an audio feed and at least one video feed at a controller, distinguishing an audio command within the audio feed using the controller, verifying a source of the audio command based on at least one of a physical action and a physical positioning corresponding to the command in the at least one video feed at the same time as the audio command in the audio feed, and implementing the command in response to the at least one of the physical action and the physical positioning being performed by an authorized user.

Another example of the above described method for verifying an audio command in a commercial vehicle further includes contextualizing the audio command based on the at least one of the physical action and the physical positioning corresponding to the command.

In another example of any of the above described methods for verifying an audio command in a commercial vehicle the at least one physical action includes a lip movement, and the source of the audio command is verified by matching a lip movement in the video feed to the command.

### BRIEF DESCRIPTION OF THE DRAWINGS

FIG. 1 schematically illustrates a commercial vehicle cab.

FIG. 2 schematically illustrates a controller for a commercial vehicle.

FIG. 3 illustrates a method for verifying that the originator of the command is authorized to issue the command.

### DETAILED DESCRIPTION

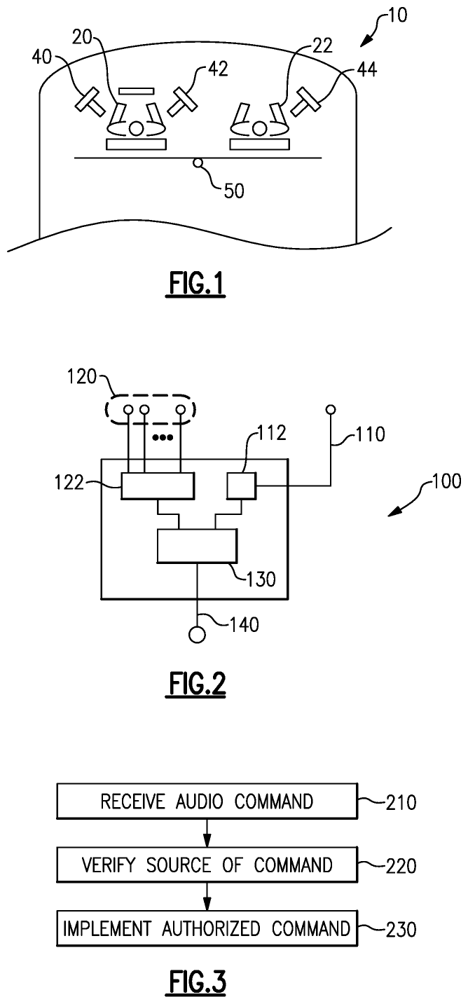

FIG. 1 schematically illustrates an exemplary commercial vehicle cab 10 including a vehicle operator 20 and a passenger 22. Multiple cameras 40, 42, 44 are disposed throughout the cab 10, with each camera 40, 42, 44 defining a corresponding field of view. In the illustrated example, two cameras 40, 42 include the vehicle operator 20 within their field of view, while one camera 44 includes the passenger 22 in its field of view. In alternative examples, more cameras with different fields of view can be utilized to provide enhanced analysis of the image feed.

In addition to the cameras, 40, 42, 44, at least one microphone 50 is included within the cab 10. The microphone 50 is sufficiently sensitive to accurately record speech at a conversational volume. In some examples, the microphone 50 can include filters to remove road noise and/or other expected operational noises from the audio. In alternative examples, the microphone 50 can pass the unfiltered noise to a controller (see FIG. 2) which can in turn filter out the road noise. While illustrated as a single microphone placed behind, and between, the operator 20 and the passenger 22, it is appreciated that the microphone 50 can be placed in multiple other locations about the vehicle cab 10 and/or additional microphones can be provided about the vehicle cab 10.

Each of the cameras 40, 42, 44 and the microphone 50, are connected to a controller 100, illustrated in FIG. 2. The controller 100 can be a general vehicle controller, of which the components illustrated in FIG. 2 are only a part, or the controller 100 can be a dedicated audio command controller 100 in communication with a general vehicle controller.

With continued reference to the vehicle cab 10 of FIG. 1, FIG. 2 illustrates an exemplary controller 100 for implementing an audio command system within the vehicle cab 10. The controller 100 includes an audio input 110 connected to the microphone 50. The audio input 110 provides the audio feed captured by the microphone 50 to an interpretation module 112 within the controller 100.

The controller 100 further includes a set of video inputs 120 with each input 120 being connected to a corresponding video camera 40, 42, 44. The inputs 120 provide the video feed from the cameras 40, 42, 44 to a verification module 122. The verification module 122 is configured to identify one or more motions or indicators corresponding to talking within each field of view. The data from the verification module 122 is compared with the interpretation module 112, in a comparison module 130. The comparison module 130 correlates the command information from the interpretation module 112 with any motions or indicators identified by the verification module 122 using a time-based correlation.

The comparison module 130 then determines when the motions or indicators are within a field of view from a camera capturing the vehicle operator 20 and provides the command via an output 140 when there is a match. In alternative configurations, such as where multiple vehicle occupants are authorized to provide a command, or when the detected command is within a set of commands that can have multiple authorized users, the comparison module 130 allows the command to be passed when any authorized vehicle operator is determined to have originated the commend.

In some specific examples, the motion or indicator identified by the verification module 122 includes lip movements corresponding to speaking. In such an example the vehicle occupant issuing the command is determined to be the one who's lips are moving simultaneously with the command being detected.

In a further example, more sophisticated controllers 100 can include a lip-reading module within the verification module 122. The lip-reading module, in one example, uses a neural network trained to interpret lip reading to determine what is being said when lip motion is detected. By way of example, the lip-reading module can be a convolutional neural network, or other neural network, trained using films of individuals speaking with associated subtitles. Training the AI using film footage including subtitles operates by first identifying one or more individual faces within the footage and tracking the individual face(s). Each time the tracked individual speaks, the corresponding subtitles act as a ground truth for the word(s) corresponding to the lip movement of the tracked face. The machine learning system identifies the lip movements during the speaking and correlates the lip movements with the ground truth words provided by the subtitles. This process is repeated for multiple faces, and multiple sets of film footage to generate a training data set of sufficient size to provide a high degree of accuracy for a machine learned lip reading algorithm.

In examples including the lip-reading module, the lip-reading can be further used to interpret the command being given. In such examples the interpretations from the lip reading and from the microphone are compared and when the determined commands from the lip reading and from the microphone match, the command is passed using the output 140.

In another example, the motion or indicator can include hand gestures, head movement or positioning, posture detection, posture changes, or any similar facial, hand, arm or upper body motion or positioning indicative of providing an audio command.

With continued reference to FIGS. 1-2, FIG. 3 illustrates the method for verifying that the originator of the command is authorized to issue the command. Initially, the microphone 50 receives audio signals and provides the audio signals to a controller in a “Receive Audio Command” step 210. Upon receipt of the audio signals, the controller matches the sound wave pattern within the audio signal to a set of predefined commands using any known matching system. When the audio signal matches a command within the predefined set of commands, the controller determines that an audio command has been issued.

Once the audio command has been identified, the controller uses the video feeds provided by the cameras 40, 42, 44 to verify that the audio command was issued by the vehicle operator, or another authorized person within the vehicle, in a “Verify Source of Command” step 220. To verify the source of the command, the controller analyzes the video feed(s) received during a time period corresponding to the time period that the command occurred on the audio signal and identifies a physical action of one or more vehicle occupant corresponding to the audio command. The controller the determines that the vehicle occupant(s) that made the physical action are the occupants that issued the command.

In one example, the physical action is lip movement corresponding to speech and the controller determines that whoever is speaking at the same time as the audio command was detected issued the command. In a more detailed examples, the controller can include a lip-reading module and only lip movement matching the issued command by at least a threshold amount is determined as the source of the command.

In alternative examples, the physical action can include a predefined gesture, a head position or gaze direction, specific posture, facial analysis, or any similar physical actions indicative of an operator issuing a command. The types of physical actions are, in one example, defined by programmed rules. In an alternative example, the physical actions corresponding to issuing a command can be provided to a machine learning algorithm and the complex interrelationships between the multiple actions and the issuance of a command are accounted for via the machine learned algorithm. As with the lip movement example, the person performing the physical action at the same time that the audio command is detected is determined to be the source of the audio command.

In a simple example, the controller can determine that any vehicle occupant in the driver's seat is authorized to issue commands. When the person performing the action is the person in the driver's seat, the driver is verified as the source. In a more complex example, multiple positions in the vehicle can be authorized for one or more commands, and/or the system can be trained to recognize specific faces for authorized commands.

Once the source of the command has been identified and verified in the “Verify Source of Command” step 220, the control outputs one or more signals to implement the command in an “Implement Authorized Command” step 230. In some examples, implementing the authorized command includes outputting effector signals that directly alter the operation of the vehicle. In alternative examples, implementing the authorized command includes providing an instruction to a general controller, such as an ECU, or to a specific controller and the other controller then converts the instruction into specific effector signals.

By implementing the above system and process the vehicle can ensure that the system only responds to authorized user commands.

In addition to limiting implementation of audio commands to only instances where an authorized operator has issued the command, the system described herein can further contextualize generic commands depending on the visual indicator that is paired with the command. As used herein, a “generic command” is a command that can be applied to more than one system or component within the vehicle. When a generic command is received, and determined to have been made by an authorized source, the controller further reviews one or more of the corresponding gestures, poses, gaze etc. of the user issuing the command and contextualizes the command based on the determined one or more of the corresponding gestures, poses, gaze, etc. to determine which system(s) or component(s) to apply the command to.

In one specific example, an audio command requesting a display zoom can be applied to multiple distinct displays within the vehicle, and may only be intended for a single display. The command is confirmed to have been issued by the authorized operator based on the gaze of the authorized operator being directed toward a display within the vehicle simultaneously with the command being issued. To provide the contextual information, the controller identifies which display is being gazed at, and the correlates the issued command (zoom) with the particular display. The controller then responds by zooming only the display that is correlated to the command. As can be appreciated, the specific example is illustrative in nature and practical implementations can include a number of distinct varied contextual command interpretations within the voice command confirmation system. By way of non-limiting example, zooming, panning, starting turn indicators, and any similar commands could be differentiated using the image based context.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A commercial vehicle comprising:
a vehicle cab including a camera system having at least one field of view, the at least one field of view including at least one of a vehicle operator seat and an expected head position of a vehicle operator in the vehicle operator seat;
at least one microphone configured to record sounds within the vehicle cab; and
a controller configured to receive the recorded sounds and video feed from the camera system, the controller being further configured to identify at least one voice command based on the received recorded sounds and confirm the at least one voice command using the video feed from the camera system.

2. The commercial vehicle of claim 1, wherein confirming the at least one voice command using the camera system video feed includes identifying a source of the voice command as being the vehicle operator using the camera system video feed.

3. The commercial vehicle of claim 2, wherein identifying the source of the at least one voice command includes detecting at least one of a physical action and a physical positioning corresponding to the command in the video feed at the same time as the audio command in the audio feed.

4. The commercial vehicle of claim 3, wherein the physical action includes at least one of lip movement, a predefined gesture, a change in head position, a change in gaze direction, a posture alteration, and facial movement.

5. The commercial vehicle of claim 3, wherein the physical action is lip movement and confirming the at least one voice command includes lip reading the vehicle operator.

6. The commercial vehicle of claim 2, wherein identifying the source of the at least one voice command includes identifying a posture or gaze direction of the vehicle operator.

7. The commercial vehicle of claim 3, wherein identifying the source of the at least one voice command further includes contextualizes the voice command to one of a plurality of eligible vehicle systems based on the at least one of the physical action and the physical positioning.

8. The commercial vehicle of claim 1, wherein the camera system includes a single camera and wherein the at least one field of view includes each of the vehicle operator seat and at least one vehicle passenger seat.

9. The commercial vehicle of claim 1, wherein the camera system includes at least two cameras, a first camera defining a field of view including the vehicle operator and a second camera defining a field of view including at least one vehicle passenger seat.

10. A commercial vehicle controller comprising:
at least one audio input configured to connect to an audio sensor and at least one video input; and
a processor and a non-transitory memory, the non-transitory memory being configured to cause the processor identify at least one voice command based on audio received at the audio input and to confirm the at least one voice command using a video feed received at the at least one video input.

11. The commercial vehicle controller of claim 10, wherein the memory includes a confirmation module configured to confirm the at least one voice command using the received video feed by identifying a source of an audio command based on a simultaneous physical action within the video feed.

12. The commercial vehicle controller of claim 11, wherein the simultaneous physical includes at least one of lip movement, a predefined gesture, a change in head position, a change in gaze direction, a posture alteration, and facial movement.

13. The commercial vehicle controller of claim 12, wherein the simultaneous physical action is the lip movement and the confirmation module includes instructions configured to convert lip movement to words.

14. The commercial vehicle controller of claim 13, wherein the instructions configured to convert lip movements to words include conversion instructions determined via machine learning trained using at least a data set of subtitled film footage.

15. The commercial vehicle controller of claim 13, wherein the simultaneous physical action includes at least one of a change in gaze direction and a change in posture, and wherein the controller is further configured to contextualize the command based at least in part on the at least one of the change in gaze direction and the change in posture.

16. The commercial vehicle controller of claim 11 at least one audio input configured to connect to an audio sensor and at least one video input, wherein the at least one video input includes at least two video inputs and a first of the at least two video inputs is configured to receive a video feed defining a field of view including an expected position of a vehicle operator.

17. A method for verifying an audio command in a commercial vehicle comprising:
receiving an audio feed and at least one video feed at a controller;
distinguishing an audio command within the audio feed using the controller;
verifying a source of the audio command based on at least one of a physical action and a physical positioning corresponding to the command in the at least one video feed at the same time as the audio command in the audio feed; and
implementing the command in response to the at least one of the physical action and the physical positioning being performed by an authorized user.

18. The method of claim 17, further comprising contextualizing the audio command based on the at least one of the physical action and the physical positioning corresponding to the command.

19. The method of claim 17, wherein the at least one physical action includes a lip movement, and the source of the audio command is verified by matching a lip movement in the video feed to the command.
